(19) United States
(12) Patent Application Publication
(10) Pub. No.: US 2026/0253527 A1
(43) Pub. Date: Aug. 27, 2026

(54) DISPLAY DEVICE AND METHOD FOR CONTROLLING DISPLAY DEVICE

(71) Applicant: Sharp Display Technology Corporation, Kameyama City (JP)

(72) Inventors: Yousuke NAKAMURA, Kameyama City (JP); Kohji SAITOH, Kameyama City (JP); Daiji KITAGAWA, Kameyama City (JP); Jin MIYAZAWA, Kameyama City (JP); Daisuke SUEHIRO, Kameyama City (JP)

(21) Appl. No.: 19/077,293

(22) Filed: Mar. 12, 2025

(30) Foreign Application Priority Data
Jan. 25, 2024 (JP) 2024-009824

(51) Int. Cl. G09G 3/20; G09G 3/36

(52) U.S. Cl. CPC G09G 3/2092; G09G 3/3677; G09G 2310/06; G09G 2320/0247; G09G 2320/0626; G09G 2330/023

(57) ABSTRACT

A display device and a method for controlling a display device are provided that are capable of reducing change in brightness even when the display device shifts from a state in which image signals are input at a short cycle to a state in which image signals are input at a long cycle. The display device includes: a pixel electrode; a driving circuit that causes the pixel electrode to be charged based on an image signal; and a control unit that controls a timing at which the pixel electrode is charged by the driving circuit. When the cycle at which image signals are input from a host changes from a cycle T1 to a cycle T2 that is longer than T1, the control unit makes the length of charging time C2 in a time period P2 in which the image signals are input at the cycle T2 that is longer than the length of charging time C1 in a time period P1 in which the image signal is input at the cycle T1.

### TECHNICAL FIELD

The present disclosure relates to a display device, and a method for controlling a display device.

### BACKGROUND ART

International Publication No. 2017/130860 describes a display device that performs pause driving in which writing to pixels is paused to display a still picture. This display device executes high-speed scanning and gradation value emphasis driving when transitioning from a pause period in which pause driving is executed to a driving period in which scanning signal lines are scanned and image signal voltages are written to pixels. The high-speed scanning is a process of writing image signal voltages of the same polarity to pixels at a second speed that is faster than a first speed at which image signal voltages obtained based on an image signal are written to the pixels. The gradation value emphasis driving refers to an operation in which the gradation values of the image data of the first frame immediately after the start of the driving period and the image data of the second frame immediately following the first frame are corrected. This allows the display device to prevent flicker from being visible when transitioning from a pause period to a driving period.

### CITATION LIST

### SUMMARY OF INVENTION

### Problem to be Solved by the Invention

Here, in some cases, the display device may shift from a period in which image signal voltages are applied to pixels (writing images) at a short cycle (for example, 120 Hz) to a period in which images are written at a long cycle (for example, 1 Hz). In this case, the number of times a pixel is charged decreases from 120 times per second to 1 time per second. Due to off-leak in a pixel TFT, the potential of the pixel (pixel electrode) decreases, causing a change (for example, a decrease) in brightness. In other words, conventional display devices have the problem of a change in brightness when shifting from a state in which image signals are input at a short cycle to a state in which image signals are input at a long cycle.

Therefore, the present disclosure is made to solve the above-mentioned problem, and is intended to provide a display device and a method for controlling a display device capable of reducing change in brightness even when the display device shifts from a state in which image signals are input at a short cycle to a state in which image signals are input at a long cycle.

### Means to Solve the Problem

To solve the above described problem, a display device according to a first aspect of the present disclosure includes: a pixel electrode; a driving circuit that causes the pixel electrode to be charged based on an image signal; and a control unit that controls a timing at which the pixel electrode is charged by the driving circuit, wherein, when a cycle at which the image signal is input from a host changes from a first cycle to a second cycle that is longer than the first cycle, the control unit makes a length of charging time in a second time period in which the image signal is input at the second cycle, longer than a length of charging time in a first time period in which the image signal is input at the first cycle.

A method according to a second aspect of the present disclosure for controlling a display device is a method for controlling a display device that includes a pixel electrode and a driving circuit that causes the pixel electrode to be charged based on an image signal, the method including: obtaining an image signal; and when a cycle at which the image signal is input from a host changes from a first cycle to a second cycle that is longer than the first cycle, making a length of charging time for charging the pixel electrode by the driving circuit in a second time period in which the image signal is input at the second cycle, longer than a length of charging time for charging the pixel electrode by the driving circuit in a first time period in which the image signal is input at the first cycle.

### BRIEF DESCRIPTION OF DRAWINGS

FIG. 1 is a block diagram showing a schematic configuration of a display device 100 in a first embodiment.

FIG. 2 is a circuit diagram showing part of a configuration of a liquid crystal display 11.

FIG. 3 is a diagram for explaining timings of a gate start pulse signal GSP, an output signal Do, and a display image Di.

FIG. 4 is a diagram for explaining the relationship between an output period of a gate clock signal GCL and a waveform of a source signal So.

FIG. 5 is a block diagram of a display device 200 according to a second embodiment.

FIG. 6 is a block diagram showing a configuration of a source driving circuit 213 according to the second embodiment.

FIG. 7 is a diagram for explaining the relationship between an output period of a gate clock signal GCL and a waveform of a source signal So during a time period P2 according to the second embodiment.

FIG. 8 is a block diagram of a display device 300 according to a third embodiment.

FIG. 9 is a diagram for explaining input/output timings of an input signal Ci, an output signal Do, and a display image Di, as well as operation timings of a frame memory 21 according to the third embodiment.

FIG. 10 is a block diagram of a display device 400 according to a fourth embodiment.

FIG. 11 is a diagram for explaining input/output timings of an input signal Ci, an output signal Do, and a display image Di, as well as operation timings of a frame memory 21 according to the fourth embodiment.

FIG. 12 is a block diagram of a display device 500 according to a fifth embodiment.

FIG. 13 is a diagram for explaining timings of a gate start pulse signal GSP, an output signal Do, and a display image Di according to the fifth embodiment.

FIG. 14 illustrates results of measuring brightness of a display device according to a comparative example.

FIG. 15 illustrates results of measuring brightness of an example of the display device 100 of the first embodiment.

### MODE FOR CARRYING OUT THE INVENTION

Embodiments of the present disclosure are described below based on the drawings. It should be noted that the present disclosure is not limited to the embodiments described below, and design modifications may be made as appropriate within the scope that satisfies the configuration of the present disclosure. In the following description, the same symbols are commonly used between different drawings for parts that are identical or have similar functions, and repeated descriptions of such parts are omitted. The respective configurations described in the embodiments and modifications may be appropriately combined or altered without departing from the gist of the present disclosure. To make the description easy to understand, in the drawings referred to hereinafter, the configurations are simply illustrated or schematically illustrated, or the illustration of part of constituent members is omitted.

### First Embodiment

### Overall Configuration of Display Device

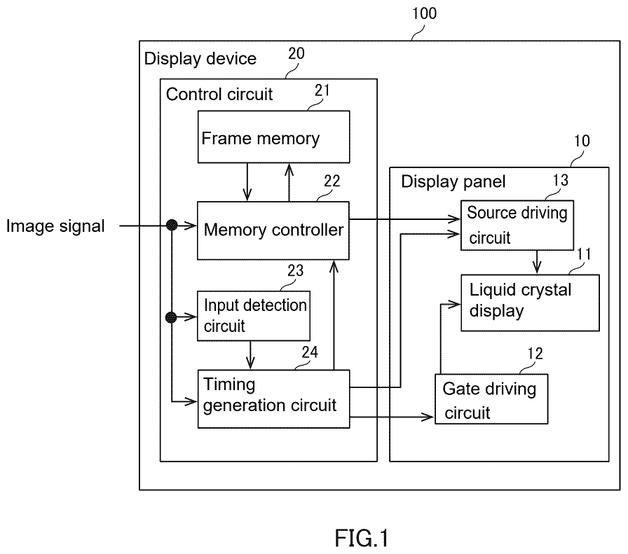

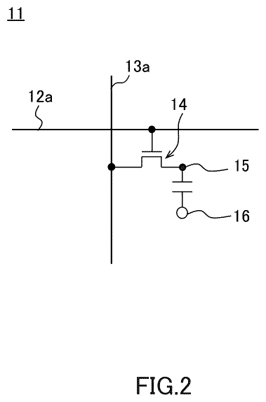

FIG. 1 is a block diagram showing a schematic configuration of a display device 100 in a first embodiment. FIG. 2 is a circuit diagram showing part of a configuration of a liquid crystal display 11. The display device 100 is a device that displays images (video) based on image signals (R, G, B) supplied from a host controller (hereinafter referred to as “host”), which is not shown in the drawings. The display device 100 is, for example, a personal computer, a tablet device, a smart phone, a smart watch, or a television device. The display device 100 includes a display panel 10 and a control circuit 20.

As illustrated in FIG. 1, the display panel 10 includes a liquid crystal display 11, a gate driving circuit 12, and a source driving circuit 13. As illustrated in FIG. 2, the liquid crystal display 11 is provided with gate lines 12a connected to the gate driving circuit 12, and source lines 13a connected to the source driving circuit 13, TFT (thin film transistors) 14, pixel electrodes 15, and a common electrode 16. The gate line 12a is connected to a gate electrode of the TFT 14. The source line 13a is connected to a source electrode of the TFT 14. The pixel electrode 15 is connected to a drain electrode of the TFT 14. The TFT 14 and the pixel electrode 15 are arranged in an area (pixel) defined by the intersection of a plurality of gate lines 12a and a plurality of source lines 13a. The common electrode 16 is a counter electrode arranged to face the pixel electrodes 15. In addition, the common electrode 16 is provided in common to the plurality of pixel electrodes 15. The pixel electrode 15 generates an electric field between itself and the common electrode 16, and the electric field drives the liquid crystal, thereby controlling the amount of light passing through the liquid crystal.

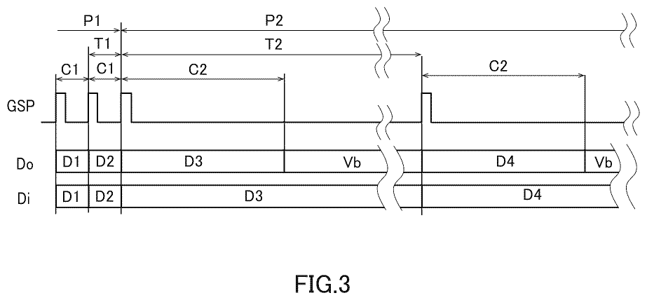

FIG. 3 is a diagram for explaining timings of a gate start pulse signal GSP, an output signal Do, and a display image Di. The gate driving circuit 12 sequentially supplies gate signals to the TFTs 14 in each row via the gate lines 12a in accordance with control signals supplied from the control circuit 20 (such as a gate start pulse signal (GSP) synchronized with a vertical synchronization signal, and a gate clock signal (GCL)). As illustrated in FIG. 3, the gate start pulse signal GSP is output once at the beginning of each frame, and serves as a trigger for the gate driving circuit 12 to start scanning one frame. Here, in the present disclosure, “frame” means an image (one frame of video) displayed on the screen to constitute video. The time interval (one frame period) at which the gate start pulse signal GSP is outputted coincides with the cycle at which an image signal is input from the host.

In addition, as illustrated in FIG. 3, the control circuit 20 supplies control signals (such as the output signal Do, the clock signals, and horizontal synchronization signals) to the source driving circuit 13. The control circuit 20 includes a memory controller 22 that generates the output signal Do based on image signals stored in the frame memory 21. The output signal Do contains information on the voltage values (pixel values) corresponding to the image signals. The source driving circuit 13 generates the source signal So (voltage) based on the output signal Do, the horizontal synchronization signal, and the like. The source driving circuit 13, then, supplies the source signal So (voltage) to the pixel electrode 15 via the source line 13a and the TFT 14, thereby charging the pixel electrode 15. In other words, the gate driving circuit 12 and the source driving circuit 13 write an image to be displayed on the liquid crystal display 11, in accordance with the input image signal. This switches the display image Di, which is the image shown on the liquid crystal display 11, as illustrated in FIG. 3. In a blank period Vb, which is a time period during which no control signals (clock signals) are supplied to the gate driving circuit 12 and source driving circuit 13 and no charging is performed to the pixel electrode 15, the display image Di written immediately before is maintained. In present disclosure, “write” is a concept that includes not only rewriting the display image Di to a different display image Di, but also writing the same display image Di again to the pixel electrode 15.

The control circuit 20 includes the frame memory 21, the memory controller 22, the input detection circuit 23, and a timing generation circuit 24, as illustrated in FIG. 1 The control circuit 20 is implemented, for example, using an integrated circuit. In FIG. 1, the control circuit 20 is illustrated as a functional block but each function in the control circuit 20 may be implemented as a separate hardware (circuit). Alternatively, the control circuit 20 may include a processor and be configured to provide the functions of the memory controller 22, the input detection circuit 23, and the timing generation circuit 24 by executing a program.

The frame memory 21 is a memory in which image signals (respective pixel values (gradation values) of R, G, and B) of each pixel for at least one entire frame are stored. The memory controller 22 performs the process of writing and reading an image signal to and from the frame memory 21. More specifically, the memory controller 22 receives an image signal from the host, and causes the frame memory 21 to store the image signal. The memory controller 22 then reads the image signal from the frame memory 21 in response to a command from the timing generation circuit 24, and supplies the output signal Do to the source driving circuit 13.

When a predetermined condition is met, the host switches from a state in which an image signal is input to the control circuit 20 at 120 Hz (frame frequency of 120 Hz) to a state in which an image signal is input to the control circuit 20 at 1 Hz (frame frequency of 1 Hz). The above-mentioned “predetermined condition” is, for example, a case where no input operation is performed continuously for a predetermined period of time on an operation unit (not shown) (operation buttons, keyboard, mouse, etc.). In this case, the host changes the cycle for inputting the image signal to the control circuit 20 from T1 to T2. In the present embodiment, a state in which an image signal is input to the control circuit 20 at 120 Hz is called a “high frequency mode,” and a state in which an image signal is input to the control circuit 20 at 1 Hz is called a “low frequency mode”. Although “120 Hz” has been given as an example of the frequency for the high frequency mode, the frequency may be “30 Hz”, “60 Hz”, “90 Hz”, or other frequencies. Also, an example of the frequency for the low frequency mode may be a frequency other than “1 Hz” that is lower than the frequency for the high frequency mode, or the input from the host may be completely stopped.

The input detection circuit 23 detects the presence or absence of an image signal input to the control circuit 20 from the host. The input detection circuit 23 detects that the cycle at which an image signal is input from the host has changed from T1 to T2. For example, in the first embodiment, when the input detection circuit 23 detects that there is no image signal input for a predetermined period of time (input has stopped), the input detection circuit 23 determines that the cycle at which an image signal is input from the host has changed from T1 to T2 (the host control mode has changed from the high frequency mode to the low frequency mode). Not limited to this example, the input detection circuit 23 may be configured to detect a mode transition (that the host control mode has changed from the high frequency mode to the low frequency mode) by receiving a mode change command (command signal) from the host. In other words, the display device 100 may be configured so that the output of image signals from the host is completely stopped and the display device 100 itself generates the timing to drive the source driving circuit 13 (PSR driving: panel self refresh driving).

The timing generation circuit 24 receives an image signal from the host. The timing generation circuit 24 generates control signals to be respectively supplied to the gate driving circuit 12 and the source driving circuit 13 (the gate start pulse signal GSP synchronized with the vertical synchronization signal, the gate clock signal GCL, the horizontal synchronization signal and the like), based on the image signal. The timing generation circuit 24 transmits control signals including the gate start pulse signal GSP to the gate driving circuit 12, and transmits control signals to the source driving circuit 13. For example, when the cycle at which an image signal is input is T1, the timing generation circuit 24 causes the gate driving circuit 12 and the source driving circuit 13 to charge pixel electrodes 15 (to write an image) at the cycle of T1. At this time, the memory controller 22 reads the image signal from the frame memory 21 and supplies the source driving circuit 13 with an output signal Do based on the image signal. As illustrated in FIG. 3, the timing generation circuit 24 changes the frame period T based on the cycle detected by the input detection circuit 23, by controlling the gate driving circuit 12 and the source driving circuit 13.

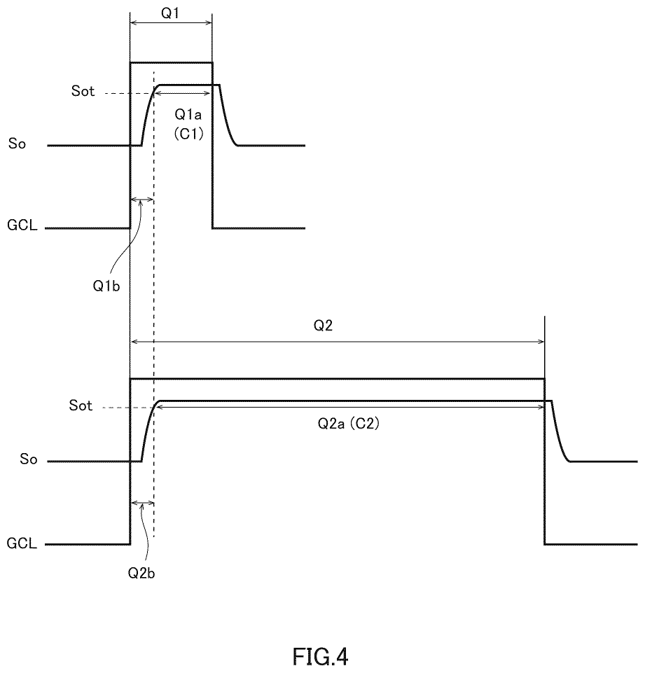

Here, in the present embodiment, as illustrated in FIG. 3, when the cycle at which an image signal is input from the host changes from the cycle T1 to the cycle T2, the timing generation circuit 24 makes the length of charging time C2 in a time period in which the image signal changes at the cycle T2 longer than the length of charging time C1 per charging in a time period P1 in which the image signal changes at the cycle T1. In the first embodiment, the length of charging time C2 is five times the length of charging time C1, but the present disclosure is not limited to this fivefold relationship. The “charging time” refers to the time during which the gate clock signal GCL is at a high level and the voltage value of the source signal So is equal to or greater than a predetermined voltage value Sot, as illustrated in FIG. 4. Therefore, in FIG. 3, the lengths of charging time C1 and C2 are illustrated to coincide with the time period when the output signal Do is output (the time period when the level of the gate clock signal GCL is High) for ease of explanation, but are not limited to this.

FIG. 4 is a diagram for explaining the relationship between an output period of the gate clock signal GCL and a waveform of the source signal So. The timing generation circuit 24 changes the length of charging time from C1 to C2 by increasing the cycle at which the horizontal synchronization signal is output (for example, by a factor of 5) and lengthening the time period for outputting the gate clock signal GCL to the gate driving circuit 12 (output period) (for example, by a factor of 5). As illustrated in FIG. 4, for example, the output period Q2 for outputting the gate clock signal GCL in the time period P2 is longer (for example, five times longer) than the output period Q1 for outputting the gate clock signal GCL in the time period P1. As a result, the length of a time period Q2a that is within the output period Q2 and during which the source signal So is equal to or exceeds the predetermined voltage value Sot is longer (for example, five times longer) than the length of a time period Q1a that is within the output period Q1 and during which the source signal So is equal to or exceeds the predetermined voltage value Sot. The source driving circuit 13, in the time period P1, outputs a voltage that causes the voltage value of the pixel electrode 15 to reach the voltage value Sot within a time Q1b from the start of charging the pixel electrode 15 (from the time point of the start of the output period), and in the time period P2, outputs a voltage that causes the voltage value of the pixel electrode 15 to reach the voltage value Sot within a time Q2b from the start of charging the pixel electrode 15. In the first embodiment, the time Q2b has the same length as that of the time Q1b. It should be noted that the “predetermined voltage value Sot” has a different value depending on the gradation value to be written to the pixel electrode 15. For example, when the gradation value to be written is high, the voltage value Sot is high, and when the gradation value to be written is low, the voltage value Sot is low.

According to the configuration of the first embodiment, when a state in which image signals are input at a short cycle is shifted to a state in which image signals are input at a long cycle, the pixel electrode 15 is also charged for a long time after the shift. This allows the potential of the pixel electrode 15 to be maintained, as compared with a case where the charging time is short. Thereby, a change (for example, decrease) in brightness can be reduced.

Incidentally, the configuration may be such that, when a state in which image signals are input at a short cycle is shifted to a state in which image signals are input at a long cycle, charging is performed a plurality of times within one cycle, without a change in the charging time per one charging. However, this configuration increases the number of times the gate driving circuit and the source driving circuit are driven, resulting in increased power consumption. In contrast, in the first embodiment, the number of times the gate driving circuit and the source driving circuit are driven is not increased, which allows a change in brightness to be reduced, while preventing power consumption from increasing.

### Second Embodiment

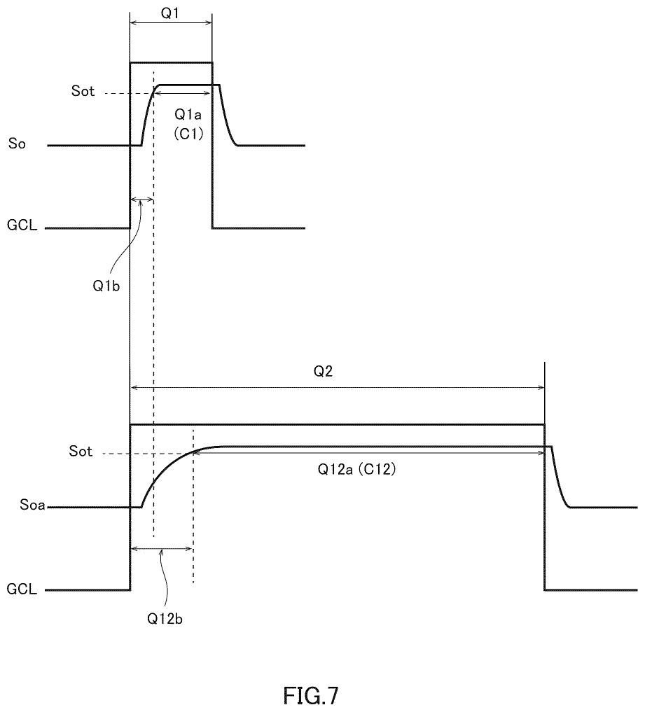

A configuration of a display device 200 according to a second embodiment is described, with reference to FIGS. 3 to 7. In the second embodiment, a time Q12b in the time period P2 (see FIG. 7) is longer than the time Q1b in the time period P1 (see FIG. 4), the time Q12b being a time from he start of charging the pixel electrode 15 to the voltage value of the pixel electrode 15 reaching the voltage value Sot. It should be noted that components having the same configuration as in the first embodiment are denoted by the same reference numerals as those in the first embodiment, and detailed description thereof is omitted.

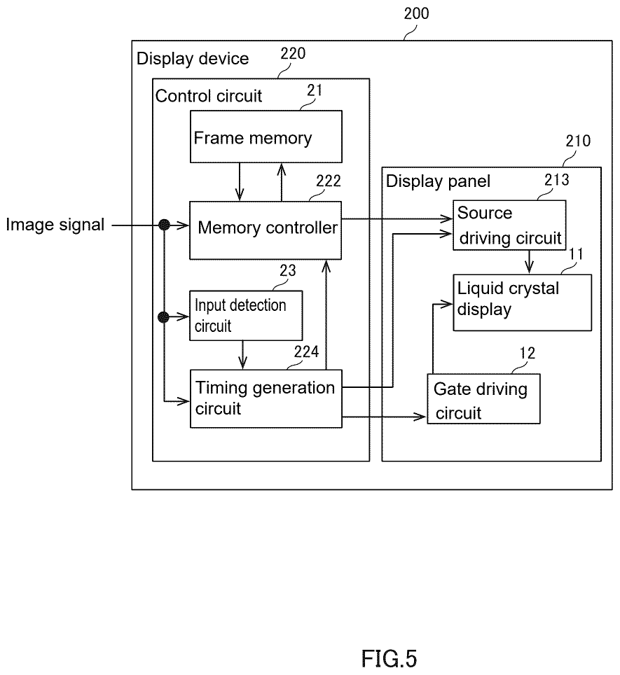

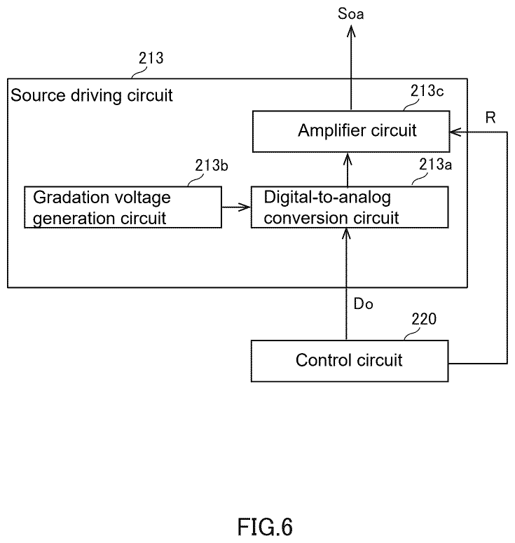

FIG. 5 is a block diagram of the display device 200 according to the second embodiment. FIG. 6 is a block diagram showing a configuration of a source driving circuit 213 according to the second embodiment. FIG. 7 is a diagram for explaining the relationship between an output period of a gate clock signal GCL and a waveform of a source signal So during a time period P2 according to the second embodiment. As illustrated in FIG. 5, the display device 200 includes a display panel 210 and a control circuit 220. The display panel 210 includes a source driving circuit 213. The control circuit 220 includes a memory controller 222, and a timing generation circuit 224. The memory controller 222 reads the image signal from the frame memory 21 and supplies the source driving circuit 213 with an output signal Do based on the image signal.

When the cycle at which an image signal is input from the host changes from the cycle T1 to the cycle T2, as illustrated in FIG. 3, the timing generation circuit 224 makes the length of charging time C12 (see FIG. 7) in a time period in which the image signal changes at the cycle T2 longer than the length of charging time C1 per charging in a time period P1 in which the image signal changes at the cycle T1. In the second embodiment, in addition, when the cycle at which an image signal is input from the host changes from the cycle T1 to the cycle T2, the timing generation circuit 224 outputs a setting change signal R to the source driving circuit 213, as illustrated in FIG. 6. The setting change signal R is a command signal for lowering the amplification capability setting of the source driving circuit 213. The source driving circuit 213, upon receiving the setting change signal R, makes a time Q12b required for the source signal So to rise longer than a time (Q1b) before receiving the setting change signal R, as illustrated in FIG. 7.

As illustrated in FIG. 6, the source driving circuit 213 includes a digital-to-analog conversion circuit 213a (DA conversion circuit), a gradation voltage generation circuit 213b, and an amplifier circuit 213c. The digital-to-analog conversion circuit 213a converts an output signal Do in digital format supplied by the memory controller 222 of the control circuit 220 into a signal in analog format and supplies the converted signal to the amplifier circuit 213c. The gradation voltage generation circuit 213b is a voltage source for the digital-to-analog conversion circuit 213a, and applies a predetermined voltage to the digital-to-analog conversion circuit 213a.

The amplifier circuit 213c is, for example, a buffer circuit that prevents attenuation of a signal output from the digital-to-analog conversion circuit 213a. The amplifier circuit 213c is, for example, a voltage follower circuit. The amplifier circuit 213c, upon receiving the setting change signal R output from the control circuit 20, makes a time Q12b required for the source signal So to rise longer than a time (Q1b) before receiving the setting change signal R. It should be noted that the function of changing the time required for the source signal So to rise by the amplifier circuit 213c can be realized by a known source driving circuit. This makes a time Q12b required for the source signal So to rise longer than a time (Q1b) before receiving the setting change signal R, as illustrated in FIG. 7. The time Q12b is longer than the time Q2b (see FIG. 4) according to the first embodiment. In other words, the source driving circuit 213, in the time period Q1, outputs a voltage that causes the voltage value of the pixel electrode 15 to reach the voltage value Sot within a time Q1b from the start of charging the pixel electrode 15, and in the time period Q2, outputs a voltage that causes the voltage value of the pixel electrode 15 to reach the voltage value Sot within a time Q12b from the start of charging the pixel electrode 15, the time Q12b being longer than the time Q1b. According to the second embodiment, the power output from the source driving circuit 213 in the time period Q2 can be reduced, thus reducing power consumption. Other configurations and effects of the second embodiment are the same as those of the first embodiment.

### Third Embodiment

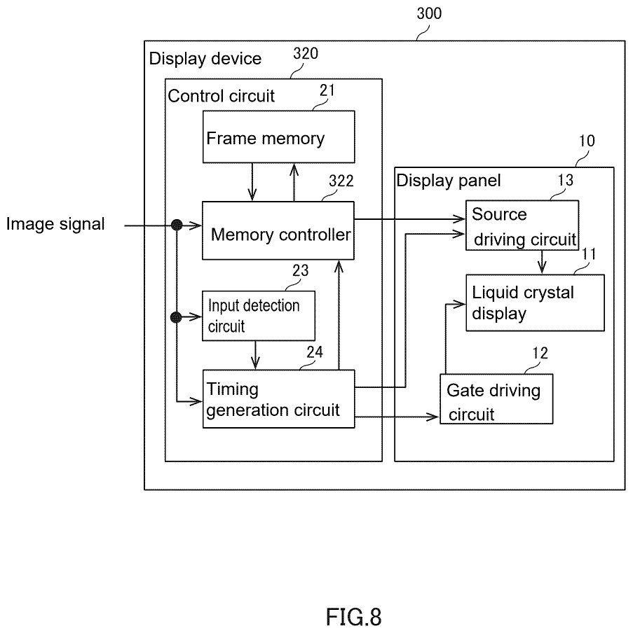

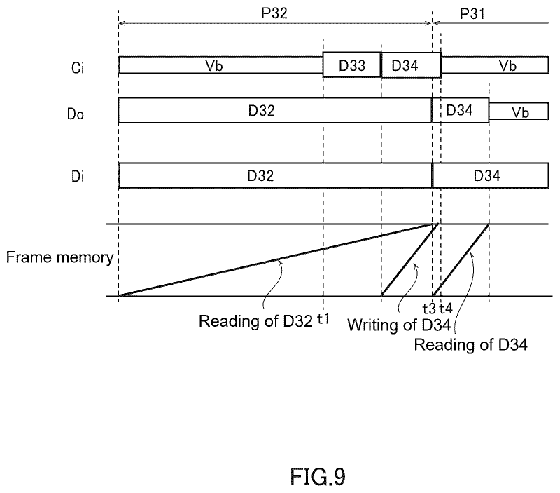

A configuration of a display device 300 according to a third embodiment is described, with reference to FIGS. 8 and 9. In the third embodiment, when a new image signal D33 is input to a control circuit 320 during charging of the pixel electrode 15 based on an image signal D32 in a time period P32 where the charging time is long (which is C2), the charging of the pixel electrode 15 based on the image signal D33 is not executed and the charging of the pixel electrode 15 based on the image signal D32 is continued. It should be noted that components having the same configuration as in the first embodiment are denoted by the same reference numerals as those in the first embodiment, and detailed description thereof is omitted.

FIG. 8 is a block diagram of the display device 300 according to the third embodiment. The display device 300 includes a control circuit 320. The control circuit 320 includes a memory controller 322.

FIG. 9 is a diagram for explaining input/output timings of an input signal Ci, an output signal Do, and a display image Di, as well as operation timings of a frame memory 21 according to the third embodiment. The input signal Ci is a signal output from the host, and an image signal is contained in the input signal C1. The memory controller 322, upon receiving an input signal Ci from the host, supplies an image signal to the frame memory 21, and writes the image signal in the frame memory 21. The memory controller 322 reads the image signal stored in the frame memory 21, and outputs the image signal thus read out, as an output signal Do, to the display panel 10. In the display panel 10, the pixel electrode 15 is charged based on the image signal.

As illustrated in FIG. 9, in the time period P32, where the charging time is C2, which is longer than C1 (see FIG. 3), the image signal D32 is read from the frame memory 21 and the output signal Do based on the image signal D32 is output from the memory controller 322. This allows the pixel electrode 15 to be charged based on the image signal D32 in the display panel 10, whereby the display image Di is displayed. Here, in the third embodiment, when a new image signal D33 as an input signal Ci is input to the control circuit 320 in the time period P32, the display device 300 does not execute the charging of the pixel electrode 15 based on the image signal D33, and continues the charging of the pixel electrode 15 based on the image signal D32. The memory controller 322 does not write the image signal D33 newly input during the time period P32 into the frame memory 21. In detail, when a new image signal D33 is input during a period from a time point t1 to a time point t2, which is prior to a time point t3 at which the time period P32 ends, the memory controller 322 does not write the image signal D33 into the frame memory 21. This prevents the image signal D32 from being overwritten by the image signal D33 in the frame memory 21 before the time point t3 when the reading of the image signal D32 is completed. As a result, it is possible to prevent the display image Di from being an image in which the image signal D33 and the image signal D32 are mixed up.

Furthermore, even if a new image signal (D34) starts to be input at the time point t2 during the time period P32, when the image signal D34 is input over a period up to a time point t4 which is after the time point t3, the end of the time period P32 (with no possibility of the image signal D32 being overwritten), the memory controller 322 writes the new image signal D34 to the frame memory 21 over the period from the time point t2 to the time point t4, as illustrated in FIG. 9. As a result, after the end of the time period P32, the output signal Do based on the image signal D34 is output to the display panel 10, and the display image Di based on the image signal D34 is displayed on the display panel 10. According to the third embodiment, even if a new image signal is input to the control circuit 320 while the pixel electrode 15 is being charged, charging of the pixel electrode 15 based on the new image signal is not executed, so that it is possible to prevent tearing (video image distortion) caused by multiple image signals colliding (overlapping) with each other. Other configurations and effects of the third embodiment are the same as those of the first embodiment.

### Fourth Embodiment

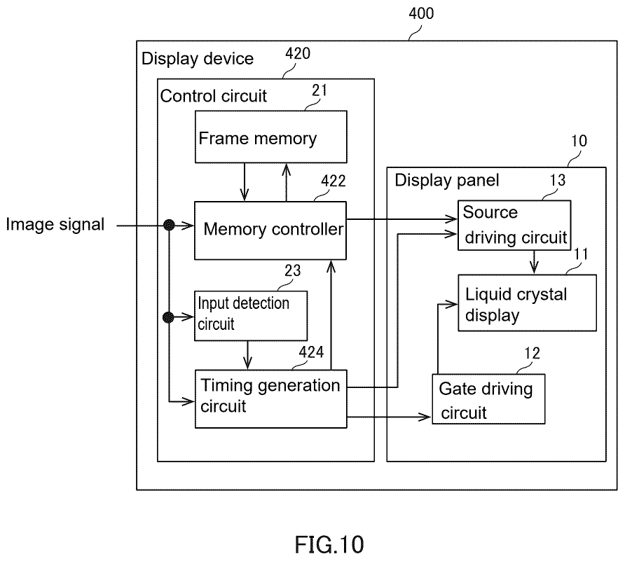

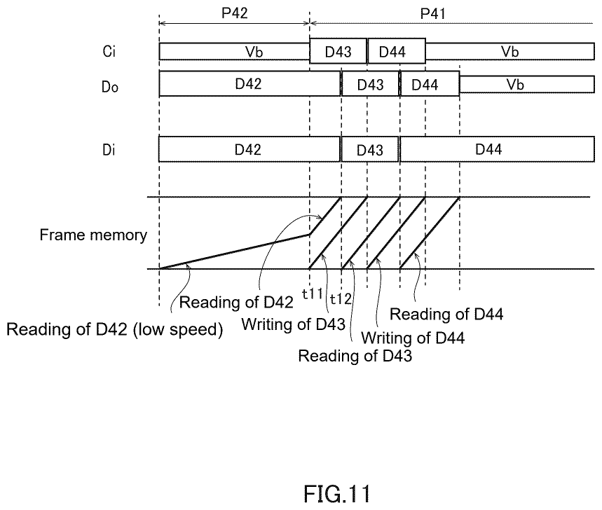

A configuration of a display device 400 according to a fourth embodiment is described, with reference to FIGS. 10 and 11. In the fourth embodiment, when a new image signal D43 is input to a control circuit 420 during charging of the pixel electrode 15 based on an image signal D42 in a time period P42 where the charging time is long (which is C2), the charging based on the image signal D42 is stopped, and the charging based on the image signal D43 is started. It should be noted that components having the same configuration as in the first embodiment are denoted by the same reference numerals as those in the first embodiment, and detailed description thereof is omitted.

FIG. 10 is a block diagram of the display device 400 according to the fourth embodiment. The display device 400 includes a control circuit 420. The control circuit 420 includes a memory controller 422.

FIG. 11 is a diagram for explaining input/output timings of an input signal Ci, an output signal Do, and a display image Di, as well as operation timings of a frame memory 21 according to the fourth embodiment. The memory controller 422, upon receiving an input signal Ci from the host, supplies an image signal to the frame memory 21, and writes the image signal in the frame memory 21. The memory controller 422 reads the image signal stored in the frame memory 21, and outputs the image signal thus read out, as an output signal Do, to the display panel 10. In the display panel 10, the pixel electrode 15 is charged based on the image signal.

As illustrated in FIG. 11, in the time period P42, where the charging time is C2, which is longer than C1 (see FIG. 3), the image signal D42 is read from the frame memory 21 and the output signal Do based on the image signal D42 is output from the memory controller 422. This allows the pixel electrode 15 to be charged based on the image signal D42 in the display panel 10, whereby the display image Di is displayed. Here, in the fourth embodiment, when a new image signal D43 as an input signal Ci is input to the control circuit 420 in the time period P42, the display device 400 ends the charging based on the image signal D42. For example, the memory controller 422 reads the image signal D42 from the frame memory 21 at a higher speed than the speed before the time point t11 when the new image signal D43 is input. This allows the memory controller 422 to quickly read the image signal D42 and finish charging the pixel electrode 15 early.

Also, the memory controller 422 starts writing the image signal D43 to the frame memory 21 at a time point t11 when the image signal D43 is input. At a time point t12 when the reading of the image signal D42 ends, the memory controller 422 starts reading the image signal D43, and outputs an output signal Do based on the image signal D43 from the time point t12. This allows the display image Di based on the image signal D43 to be displayed on the display panel 10. Then, in a time period P41 that is a time period in which the charging time is C1, the memory controller 422 outputs an output signal Do based on an input image signal D44. In this way, in the fourth embodiment, even when a new image signal D43 is input to the control circuit 420 during charging of the pixel electrode 15, the charging of the pixel electrode 15 based on the image signal D43 is started, after the charging of the pixel electrode 15 based on the image signal D42 is stopped. As a result, it is possible to prevent tearing (video image distortion) from occurring due to collision (overlapping) of the image signal D42 and the image signal D43. In other words, it is possible to prevent the display image Di from being an image in which the image signal D43 and the image signal D42 are mixed up. Other configurations and effects of the fourth embodiment are the same as those of the first embodiment.

### Fifth Embodiment

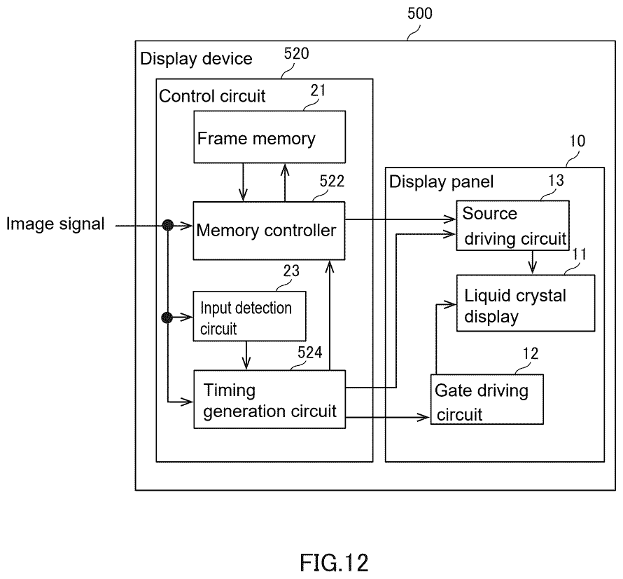

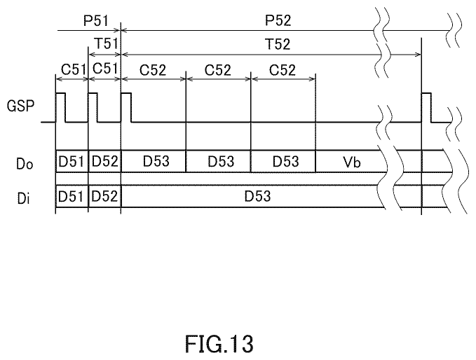

A configuration of a display device 500 according to a fifth embodiment is described, with reference to FIGS. 12 and 13. In the fifth embodiment, when the cycle at which an image signal is input from the host changes from a cycle T51 to a cycle T52 which is longer than the cycle T51, the display device 500 charges the pixel electrode 15 based on the same image signal multiple times within a time period P52 for the cycle T52. It should be noted that components having the same configuration as in the first embodiment are denoted by the same reference numerals as those in the first embodiment, and detailed description thereof is omitted.

FIG. 12 is a block diagram of the display device 500 according to the fifth embodiment. The display device 500 includes a control circuit 520. The control circuit 520 includes a memory controller 522, and a timing generation circuit 524.

FIG. 13 is a diagram for explaining timings of a gate start pulse signal GSP, an output signal Do, and a display image Di according to the fifth embodiment. When it is detected by the input detection circuit 23 that the cycle has changed from the cycle T51 to the cycle T52, which is longer than the cycle T51, the timing generation circuit 524 changes the cycle for outputting the gate start pulse signal GSP from the cycle T51 to the cycle T52. Then, the timing generation circuit 524 makes the length of charging time C52 in a time period P52 in which the image signal changes at the cycle T52 longer than the length of charging time C51 per charging in a time period P51 in which the image signal changes at the cycle T51. For example, C52 is twice as long as C51. In the fifth embodiment, the memory controller 522 outputs the output signal Do to the display panel 10 multiple times (three times in the example of FIG. 13) within the time period P52, and the pixel electrode 15 is charged based on the same image signal D53 multiple times (three times in the example of FIG. 13) in the display panel 10.

According to the fifth embodiment, even when a state with the short cycle T51 is shifted to a state with a long cycle (T52), the pixel electrode 15 is charged based on the same image signal multiple times within one cycle, which makes the period while the pixel electrode 15 is charged longer, as compared with a case where the charging is executed only once. This makes it possible to reduce a change in brightness of the display device 500. Other configurations and effects of the fifth embodiment are the same as those of the first embodiment.

### Results of Measuring Brightness in Example According to the First Embodiment and Comparative Example

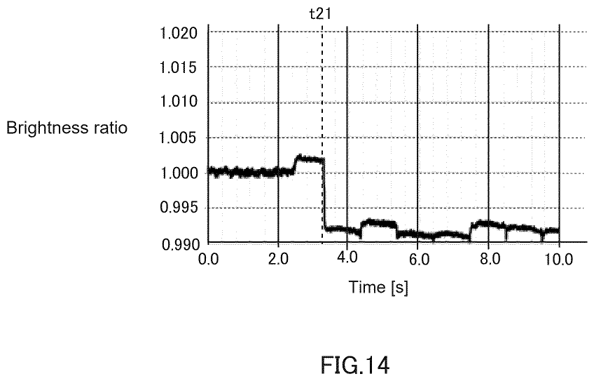

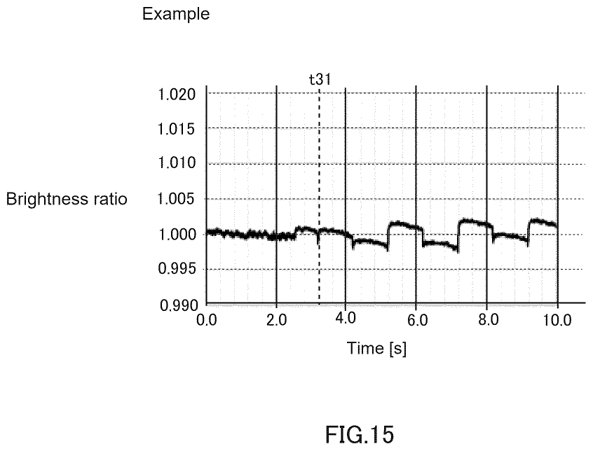

Results of measuring brightness in examples and comparative examples according to the first embodiment are described below with reference to FIGS. 14 and 15.

FIG. 14 shows measurement results of the brightness of the display device in Comparative Example. The brightness in the state where the image signal is input at a cycle of 8.3 ms (frequency is 120 Hz) from the host is given as “1”, and the ratio of brightness after the cycle has changed from 8.3 ms to 1 s (frequency is 1 Hz) is shown. In the display device according to Comparative Example, the charging time is C1 (see FIG. 3) during both the time period when the cycle is 8.3 ms (before the time point t21) and the time period when the cycle is 1 s (after the time point t21). The display device according to Comparative Example is prepared for the purpose of comparison with Example of the first embodiment and does not represent the prior art.

FIG. 15 illustrates results of measuring brightness of an example of the display device 100 of the first embodiment. In the present example, the display device 100 of the first embodiment has a configuration in which the cycle T1 is set to 8.3 ms (frequency is 120 Hz), the cycle T2 is set to 1 s, and C2 is set to five times as long as C1. FIG. 15 shows the ratio of brightness after the cycle has changed from T1 (8.3 ms) to T2 (1 s), with respect to the brightness of the display device 100 at the cycle T1, which is given as “1”. The time period before the time point t31 in FIG. 15 is the time period (P1) when the pixel signal is input at the cycle T1, and the time period after the time point t31 is the time period (P2) when the image signal is input at the cycle T2.

As illustrated in FIG. 14, in the display device according to Comparative Example, after the time point t21, the ratio of brightness was in a range of 0.990 or more and 0.993 or less. Therefore, it was found that the brightness of the display device according to Comparative Example decreased at a rate of 0.007 or more and 0.010 or less. In contrast, as illustrated in FIG. 15, in the display device according to Example, the ratio of brightness remained within a range of 0.997 or more and 1.002 or less, even after the time point t31. Thus, in the display device according to Example, the change in the ratio of brightness was found to be less than 0.003 even after the time point t31. As a result, it was found that the display device according to Example reduced the change in brightness compared to the display device according to Comparative Example.

### Modification Example

Embodiments of the present invention are described above, but the above-described embodiments are merely examples for implementing the present invention. The present invention, therefore, is not limited to the above-described embodiment, and the above-described embodiment can be appropriately varied and implemented without departing from the spirit and scope of the invention. Modifications of the above-described embodiment are described below.
(1) In the first to fifth embodiments above, an example is shown in which the host controller switches the low frequency mode and the high frequency mode, but the present disclosure is not limited to this. The control circuit of the display device may perform control to switch between low frequency mode and the high frequency mode.
(2) In the first to fifth embodiments above, an example is shown in which the liquid crystal display is provided in the display panel, but the present disclosure is not limited to this. For example, an organic EL display may be provided in the display panel.
(3)In the first to fourth embodiments above, an example is shown in which the length of charging time C2 or C12 in the time period P2 is set to five times the length of charging time C1 in the time period P1, and in the fifth embodiment above, an example is shown in which the length of charging time C52 in the time period P52 is set to twice the length of charging time C51 in the time period P51, but the present disclosure is not limited to this. For example, C2 (or C12) or C52 may be set to a value less than twice but greater than one time the value of C1 or C51, or a value greater than twice but less than five times, or a value greater than 5 times.
(4) In the fifth embodiment above, an example is shown in which writing is performed multiple times in the first half of one cycle, but the present disclosure is not limited to this. For example, writing may be performed multiple times in the second half of one cycle, or writing may be performed multiple times distributedly within one cycle.
(5) In the first to sixth embodiments above, an example is shown in which the input detection circuit that detects the cycle of change of the image signal is provided in the display device, but the present disclosure is not limited to this.

For example, the function of the input detection circuit may be provided outside of the display device (e.g., in the host). In this case, the host may be configured to send, to the display device, a signal indicating the length of the frame period (frame rate) or a signal indicating that the length of the frame period has changed. The display device may be further configured to determine the change in the cycle by receiving the above-described signal.

The above-described configuration can also be described as follows.

A display device according to a first configuration includes: a pixel electrode; a driving circuit that causes the pixel electrode to be charged based on an image signal; and a control unit that controls a timing at which the pixel electrode is charged by the driving circuit, wherein, when a cycle at which the image signal is input from a host changes from a first cycle to a second cycle that is longer than the first cycle, the control unit makes a length of charging time in a second time period in which the image signal changes at the second cycle, longer than a length of charging time in a first time period in which the image signal changes at the first cycle (first configuration).

According to the first configuration, when a state in which image signals are input at a short cycle is shifted to a state in which image signals are input at a long cycle, the pixel electrode is also charged for a long time after the shift. This allows the potential of the pixel electrode to be maintained, as compared with a case where the charging time is short. Thereby a change in brightness can be reduced.

The first configuration may be further configured so that the control unit makes the length of charging time in the second time period twice or more than the length of charging time in the first time period (second configuration). The second configuration may be further configured so that the control unit makes the length of charging time in the second time period five times or more than the length of charging time in the first time period (third configuration).

According to the second or third configuration above, the length of charging time can be sufficiently long to reduce changes in brightness.

Any one of the first to third configurations may be configured so that the driving circuit outputs, in the first time period, a voltage that causes a voltage value of the pixel electrode to reach a predetermined voltage value within a first time from start of charging to the pixel electrode, and in the second time period, outputs a voltage that causes the voltage value of the pixel electrode to reach the predetermined voltage value within a second time from start of charging to the pixel electrode, the second time being longer than the first time (fourth configuration).

According to the fourth configuration, the power output from the driving circuit in the second time period can be reduced, thus reducing power consumption.

Any one of the first to fourth configurations may be configured so that, when a new image signal, which is a second image signal, is input to the control unit during charging of the pixel electrode by the driving circuit based on a first image signal in the second time period, the control unit continues the charging of the pixel electrode by the driving circuit based on the first image signal, without executing the charging of the pixel electrode based on the second image signal (fifth configuration).

According to the fifth configuration, even if a new image signal, which is the second image signal, is input to the control unit during charging of the pixel electrode, charging of the pixel electrode based on the second image signal is not executed, so that it is possible to prevent tearing (video image distortion) caused by collision (overlapping) of the first image signal and the second image signal.

Any one of the first to fourth configurations may be configured so that, when a new image signal, which is a second image signal, is input to the control unit during charging of the pixel electrode by the driving circuit based on a first image signal in the second time period, the control unit stops the charging of the pixel electrode by the driving circuit based on the first image signal, and after stopping the charging of the pixel electrode by the driving circuit based on the first image signal, the control unit starts the charging of the pixel electrode by the driving circuit based on the second image signal (sixth configuration).

According to the sixth configuration, even if a new image signal, which is the second image signal, is input to the control unit during charging of the pixel electrode, charging of the pixel electrode based on the second image signal is started after the charging of the pixel electrode based on the first image signal is stopped, so that it is possible to prevent tearing (video image distortion) caused by collision (overlapping) of the first image signal and the second image signal.

Any one of the first to sixth configurations may be configured so that, when the cycle at which an image signal is input from the host changes from the first cycle to the second cycle, the control unit causes the pixel electrode to be charged based on the same image signal multiple times by the driving circuit within one cycle while the image signal is input (seventh configuration).

According to the seventh configuration, even when a state in which image signals are input at a short cycle is shifted to a state in which image signals are input at a long cycle, the pixel electrode is charged based on the same image signal multiple times within one cycle, which makes the time period while the pixel electrode is charged longer, as compared with a case where the charging is executed only once. This makes it possible to reduce a change in brightness.

A method according to an eighth configuration for controlling a display device is a method for controlling a display device that includes a pixel electrode and a driving circuit that causes the pixel electrode to be charged based on an image signal, the method including: obtaining an image signal; and when a cycle at which the image signal is input from a host changes from a first cycle to a second cycle that is longer than the first cycle, making a length of charging time for charging the pixel electrode by the driving circuit in a second time period in which the image signal changes at the second cycle, longer than a length of charging time for charging the pixel electrode by the driving circuit in a first time period in which the image signal changes at the first cycle (eighth configuration).

According to the eighth configuration, when a state in which image signals are input at a short cycle is shifted to a state in which image signals are input at a long cycle, the pixel electrode is also charged for a long time after the shift. This allows the potential of the pixel electrode to be maintained, as compared with a case where the charging time is short. Thereby a change in brightness can be reduced.

### DESCRIPTION OF REFERENCE NUMERALS

10: display panel
11: liquid crystal display
12: gate driving circuit
12a: gate line
13: source driving circuit
13a: source line
15: pixel electrode
16: common electrode
20: control circuit
21: frame memory
22: memory controller
23: input detection circuit
24: timing generation circuit
100: display device
200: display device
210: display panel
213: source driving circuit
213a: digital-to-analog conversion circuit
213b: gradation voltage generation circuit
213c: amplifier circuit
220: control circuit
222: memory controller
224: timing generation circuit
300: display device
320: control circuit
322: memory controller
400: display device
420: control circuit
422: memory controller
500: display device
520: control circuit
522: memory controller
524: timing generation circuit

1. A display device comprising:
a pixel electrode;
a driving circuit that causes the pixel electrode to be charged based on an image signal; and
a control unit that controls a timing at which the pixel electrode is charged by the driving circuit,
wherein, when a cycle at which the image signal is input from a host changes from a first cycle to a second cycle that is longer than the first cycle, the control unit makes a length of charging time in a second time period in which the image signal is input at the second cycle, longer than a length of charging time in a first time period in which the image signal is input at the first cycle.

2. The display device according to claim 1, wherein the control unit makes the length of charging time in the second time period twice or more than the length of charging time in the first time period.

3. The display device according to claim 2, wherein the control unit makes the length of charging time in the second time period five times or more than the length of charging time in the first time period.

4. The display device according to claim 1,
wherein the driving circuit, in the first time period, outputs a voltage that causes a voltage value of the pixel electrode to reach a predetermined voltage value within a first time from start of charging to the pixel electrode, and
the driving circuit, in the second time period, outputs a voltage that causes the voltage value of the pixel electrode to reach the predetermined voltage value within a second time from start of charging to the pixel electrode, the second time being longer than the first time.

5. The display device according to claim 1, wherein, when a new image signal, which is a second image signal, is input to the control unit during charging of the pixel electrode by the driving circuit based on a first image signal in the second time period, the control unit continues the charging of the pixel electrode by the driving circuit based on the first image signal, without executing the charging of the pixel electrode based on the second image signal.

6. The display device according to claim 1,
wherein, when a new image signal, which is a second image signal, is input to the control unit during charging of the pixel electrode by the driving circuit based on a first image signal in the second time period, the control unit stops the charging of the pixel electrode by the driving circuit based on the first image signal, and
after stopping the charging of the pixel electrode by the driving circuit based on the first image signal, the control unit starts the charging of the pixel electrode by the driving circuit based on the second image signal.

7. The display device according to claim 1, wherein, when the cycle at which the image signal is input from a host changes from the first cycle to the second cycle, the control unit causes the pixel electrode to be charged based on the same image signal multiple times by the driving circuit within one cycle while the image signal is input.

8. A method for controlling a display device that includes a pixel electrode and a driving circuit that causes the pixel electrode to be charged based on an image signal, the method comprising:
obtaining an image signal; and
when a cycle at which the image signal is input from a host changes from a first cycle to a second cycle that is longer than the first cycle, making a length of charging time for charging the pixel electrode by the driving circuit in a second time period in which the image signal is input at the second cycle, longer than a length of charging time for charging the pixel electrode by the driving circuit in a first time period in which the image signal is input at the first cycle.
